(19) United States
(12) Patent Application Publication
(10) Pub. No.: US 2004/0256571 A1
(43) Pub. Date: Dec. 23, 2004

(54) Cell cultivating and detecting device

(75) Inventors: Kayuri Muraki, Tokyo (JP); Akiko Fujinoki, Tokorozawa-shi (JP); Shinichi Dosaka, Tsukui-gun (JP)

Correspondence Address: SCULLY SCOTT MURPHY & PRESSER, PC, 400 GARDEN CITY PLAZA, GARDEN CITY, NY, 11530

(73) Assignee: OLYMPUS CORPORATION, TOKYO (JP)

(21) Appl. No.: 10/870,640

(22) Filed: Jun. 17, 2004

(30) Foreign Application Priority Data
Jun. 19, 2003 (JP) PATENT2003-174810

(51) Int. Cl. G01N 21/64

(52) U.S. Cl. 250/458.1

(57) ABSTRACT

The present invention improves the observation efficiency and makes possible detecting predetermined data from cells in a culture by a small scale and simple scanning optical system. The invention provides a cell cultivating and detecting unit comprising a stationary light source that generates a collimated light, an irradiation unit that irradiates the cells with the collimated light incident from the light source and emits the light emitted from the cells; a detecting unit that detects the light emitted from the irradiation unit, and wherein the irradiation unit can move in a direction parallel to the collimated light.

### BACKGROUND OF THE INVENTION

1. Field of the Invention

The present invention relates to a cell cultivating and detecting device that detects data that depends on the response of cells in a culture.

This application is based on Japanese Patent Application No. 2003-174810, the contents of which are incorporated herein by reference.

2. Description of the Related Art

Accompanying the recent advances in genetic technology, the genetic sequence of many organisms, including humans, has become clear. In addition, the causal relationship between analyzed genetic products such as proteins and disease is gradually starting to be elucidated. In addition, consideration of the various search methods and devices that use cells for analyzing comprehensively and statistically the various proteins and genes has started. In particular, in order to carry out this type of analysis, it is necessary to detect predetermined data while cultivating cells over a long period of time. Thus, a device is required that can cultivate and observe cells under a microscope for a long period of time.

A device that uses a transparent incubating cultivating vessel for microscopic observation in which it is possible to set the cultivating conditions for various types of cells is known (for example, refer to Japanese Unexamined Patent Application, No. 10-28576, paragraph numbers 0004 to 0007 and FIGS. 1 to 4).

This transparent incubating cultivating vessel for microscopic observation has a pair of transparent heating plates whose temperature can be controlled by a temperature adjusting device, a carbon dioxide supply inlet and a carbon dioxide outlet for adjusting the concentration of carbon dioxide inside the vessel, and an evaporating dish for maintaining a constant humidity within the vessel that is closed by a sealing packing.

It is possible to carry out observation while cultivating the cells because the temperature, the carbon dioxide concentration, and humidity within the vessel can be controlled by observations using this transparent incubating cultivating vessel for microscopic observation. That is, by carrying out observation using, for example, an objective lens from below the transparent heating plate, it is possible to observe changes in the state of cultivation of the cells through time.

Therefore, when carrying out observation of the state of the cultivation of various types of cells or recording photographic images in fields of research related, for example, to organisms, reproduction, and biotechnology, it becomes possible to set the various cultivation states by freely controlling the carbon dioxide concentration and humidity according to the observations using this transparent incubating cultivating vessel for microscopic observation. Thereby, it is possible to carry out observation and recording of changes through time continuously and easily.

In particular, cells differ in terms of genetics, and thus various types of fluorescence detection are used in vivo as measurement techniques. The detection of GFP (green fluorescent protein) expression in the cell is an example of this detection. Thus, the management of the environmental conditions for cultivating cells is a crucial requirement for obtaining correct observation results. Therefore, it is necessary to manage the temperature and carbon dioxide concentration in the cultivating vessel that is disposed under a microscope so that the cells are not killed because of the long-term microscopic observation. Examples of the cultivating vessels include plastic or glass dishes or laboratory dishes.

### SUMMARY OF THE INVENTION

In a first aspect, the present invention is a cell cultivating and detecting device that irradiates cells in a culture on a carrier with light and detects fluorescent light emitted from the cells, and provides a stationary light source that generates collimated light, an irradiation unit that irradiates cells with the collimated light incident from the light source and emits the fluorescent light that is emitted by the cells, a stationary detecting unit that detects the fluorescent light emitted from the irradiation unit, and wherein the incident direction and the emitting direction are arranged so as to be substantially parallel, and the irradiation unit can move in a direction parallel to the incident direction and the emitting direction.

### BRIEF DESCRIPTION OF THE DRAWINGS

FIG. 1 is a perspective diagram showing a first embodiment of the cell cultivating and detecting device according to the present invention.

FIG. 2 is a lateral cross-sectional drawing of the cell cultivating and detecting device shown in FIG. 1.

FIG. 3 is a cross-sectional drawing of the cell cultivating and detecting device shown in FIG. 2 along the line B-B.

FIG. 4 is a lateral cross-sectional drawing showing the second embodiment of the cell cultivating and detecting device according to the present invention.

FIG. 5 is a cross-sectional drawing of the cell cultivating and detecting device shown in FIG. 4 along the line C-C.

FIG. 6 is a structural diagram showing another modification of the cell cultivating and detecting device.

FIG. 7 is a lateral cross-sectional drawing showing the third embodiment of the cell cultivating and detecting device according to the present invention.

FIG. 8 is a lateral cross-sectional drawing showing the fourth embodiment of the cell cultivating and detecting device according to the present invention.

FIG. 9 is a lateral cross-sectional drawing showing the fifth embodiment of the cell cultivating and detecting device according to the present invention.

### DETAILED DESCRIPTION OF THE INVENTION

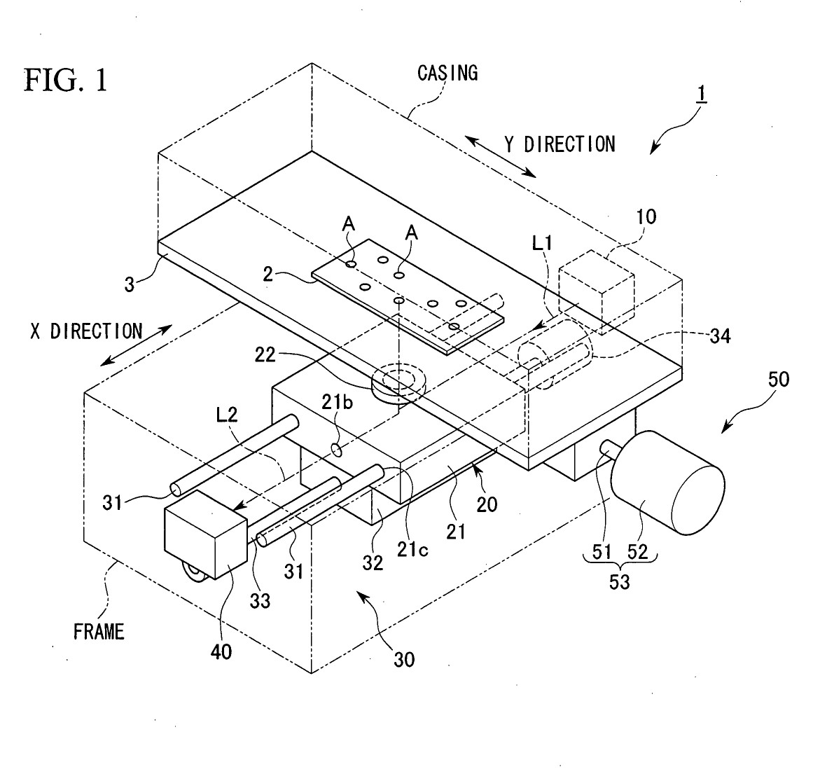

Below, a first embodiment of the cell cultivating and detecting device according to the present invention will be explained with reference to FIG. 1 through FIG. 3.

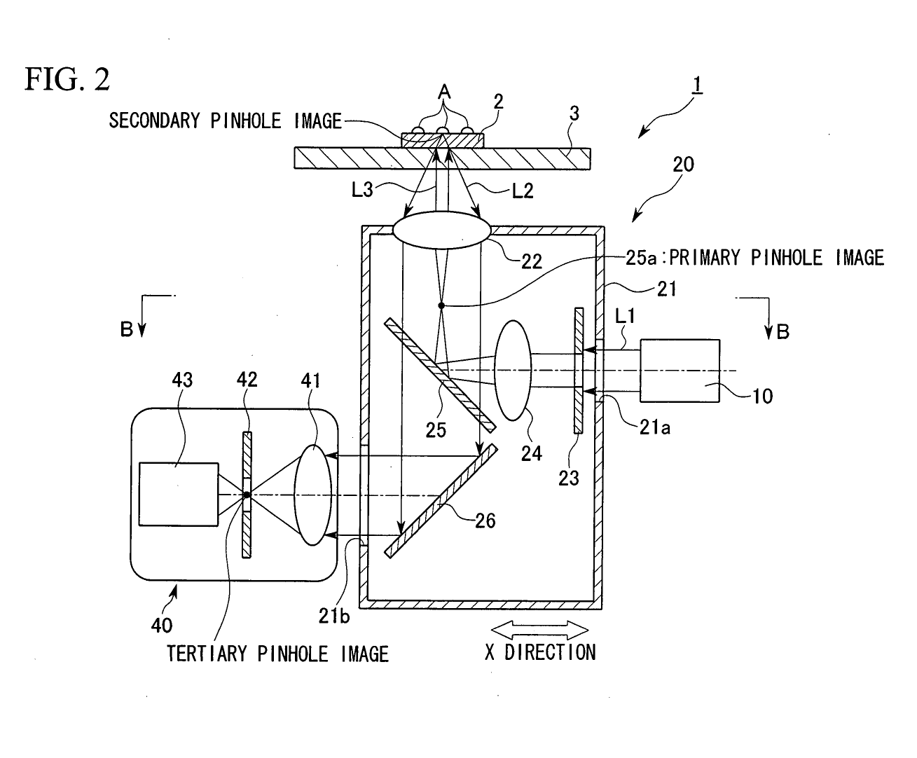

The cell cultivating and detecting device 1 of the present embodiment is an apparatus that irradiates cells A in a culture on a glass slide (carrier) 2 with light, as shown in FIG. 1 and FIG. 2, and detects the fluorescent light L2 emitted by the cells A. In addition, the cell cultivating and detecting device 1 consists of a stationary light source 10 that generates a collimated light L1, a moving optical unit (irradiation unit) 20 that irradiates cells A with the collimated light incident from the light source 10 and emits fluorescent light L2 emitted by the cells A, and a stationary detecting unit 40 that detects the fluorescent light L2 irradiated from the moving optical unit 20, and a carrier conveying unit 50 that movably supports the glass slide 2.

The light source 10 and the detecting unit 40 are arranged such that the incident direction and emitting direction are substantially parallel. Specifically, the detecting unit 40 is arranged so as to be opposite to the light source 10 with the moving optical unit 20 interposed therebetween. In addition, the moving optical unit 20 can move in the X direction, which is parallel to the incident direction and the emitting direction.

The glass slide 2 is formed into a plate shape, a plurality of cells A are sequentially disposed in an array shape on the surface thereof, and supported and cultivated. This glass slide 2 is mounted on the stage 3. Note that the stage 3 is formed by a transparent material such as transparent glass, and that the cells A can be irradiated with light through the stage 3 and the glass slide 2 from the bottom of the stage 3. In addition, the stage 3 is accommodated in a casing, as shown, for example, in FIG. 1, and is adjusted such that the temperature is 37°, the humidity is 100%, and the concentration of carbon dioxide is 5%. Thereby, the cells A are cultivated on the glass slide 2 in an optimal environment.

The light source 10 is below the stage 4 and is stationary to an installation stand (not illustrated) in the frame. It is a laser light source that generates a laser light consisting of a collimated light beam having a predetermined diameter. The wavelength of the laser light is selected depending on the excitation profile of the fluorescent dye. For example, the wavelength excitation profile is 489 nm in the case of S65T-GFP. Note that GFP is a fluorescent substance characterized in generating green light when excited by blue light.

The moving optical unit 20 is disposed below the stage 3 as shown in FIG. 2, and an objective lens 22 that converts the fluorescent light L2, which is dispersed light produced by the cells A, to collimated light, an excitation pinhole (projective pinhole) 23 that is disposed along the optical path of the collimated light L1 incident from the light source 10, a projective lens 24 that is disposed so as to align the upstream focal point with the excitation pinhole 23 and focus the light that has passed through the excitation pinhole 23, a first wavelength selection element (deflecting element) that deflects the light that has passed through the projective lens 24 towards the cells A, and a second wavelength selection element 26 that deflects the collimated light converted by the objective lens 22 to emit it towards the detecting unit 40 are provided in the case 21.

The case 21 is formed in the shape of a box, an entrance opening 21a that admits the collimated light L1 on the light source 10 side is provided, and on the side opposite to the entrance opening 21a, that is, the detecting unit 40 side, an exit opening 21b that emits the fluorescent light L2 is provided. Inside the entrance opening 21a, the excitation pinhole 23 is provided. This excitation pinhole 23 is a plate-shaped material in which a small pinhole is provided, and has the function of shaping (stopping) the diameter of the collimated light L1. In addition, downstream of the excitation pinhole 23, the objective lens 24 is disposed. In addition, downstream of the projective lens 24, the first wavelength selection element 25 is provided on the optical path such that the optical path of the light that has been focused by the projective lens 24 is deflected 90° (upwards with respect to the page surface). This first wavelength selection element 25 is, for example, a dichroic mirror, transmits only the wavelength of the fluorescent light (including the fluorescent light produced by the cells) emitted by the cells A, and has the function of reflecting the light having any other wavelength.

The objective lens 22 is an objective lens having an infinite-point design with a high magnification of about 20 times, and is mounted in the case 20 so as to be positioned immediately above the first wavelength selection element 25, that is, on the reflected optical path of the first wavelength selection element 25. In addition, the objective lens 22 has the function of converting the light that has been focused at the focal point position 25a downstream of the first wavelength selection element 25 to irradiate the cells A. Specifically, the objective lens 22 has the function of irradiating the cells A from below by making the light reflected by the first wavelength selection element 25 pass through the stage 3 and the glass slide 2 as a narrow collimated light beam, that is, a spot of light L3 consisting of collimated light.

The second wavelength selection element 26 has the function of reflecting substantially 100% of the parallel fluorescent light component (light having only a predetermined wavelength) emitted by the cells and cutting light having any other wavelengths. The second wavelength selection element 26 is below the first wavelength selection element 25, that is, on the transmitting optical path of the first wavelength selection element 25, and is disposed at a position where the light that has passed through the first wavelength selection element 25 is emitted from the exit opening 21b after being deflected 90° (in the left direction with respect to the page surface). Thereby, the fluorescent light L2 that has been converted to collimated light by the objective lens 22 is deflected by the second wavelength selection element 26 after having passed through the first wavelength selection element 25. Then the fluorescent light L2 is emitted from the exit opening 21b.

As shown in FIG. 1, the moving optical unit 20 provides an optical unit drive mechanism 30 that moves the case 21 in the X direction. The optical unit drive mechanism 30 provides a pair of guide rails 31, a bracket 32 connected to the case 21, a ball screw 33 that rotatably engages the bracket, and a stepping motor 34 that rotates the ball screw 33.

Specifically, a pair of guide rail holes 21c are formed in the X direction on the case 21, and, for example, a pair of guide rails 31, which are round rods of stainless steel or the like, are inserted into the guide rail holes 21c so as to be able to slide therein. Thereby, the case 21 can smoothly move in the X direction along the guide rails 31.

Note that, for example, ball bearings, self-lubricating bearings or the like can be provided in the pair of guide rail holes 21c. In this case, an even lower sliding friction can be obtained.

The bracket 32 is connected under the case 21, and a ball screw 33 is inserted towards the X direction. In addition, a stepping motor 34 is connected to the end of the ball screw 33. That is, the ball screw 33 is rotated by actuating the stepping motor 34, and thereby the case 21 can be moved in the X direction along with the frame 32.

Note that a control unit (not illustrated) carries out the actuation control of the stepping motor 34. In addition, the guide frame 31, the ball screw 33, and the stepping motor 34 are fastened inside the frame.

The detecting unit 40 is fastened to an installation stand (not illustrated) within the frame, and, as shown in FIG. 2, provides an image forming lens that forms the fluorescent light L2 emitted from the irradiation unit 20 into an image and a light detector 43 that consists of a photomultiplier, avalanche photodiode, a CCD, a line sensor or a combination thereof. The detecting unit 40 is a plate shaped member provided at the image forming position of the image forming lens 41 and detects the fluorescent light L2 that has passed through the light receiving pinhole 42 and the light receiving pinhole 41. Note that the light receiving pinhole 42 can be formed such that, depending on the object of the measurement, a plurality of types having differing pinhole diameters can be arbitrarily and automatically switched so as to carry out various types of detection.

As shown in FIG. 1, the carrier conveying unit 50 supports the glass slide 3 so as to be able to slide in the Y direction, which is perpendicular to the X direction, and provides the stage 3, a ball screw 51 that engages the stage 3 so as to be able to rotate, and a stepping motor 52 that rotates the ball screw 51. Specifically, the ball screw 51 is rotated by driving the stepping motor 52, and thereby the glass slide 2 can be moved in the Y direction along with the stage 3. In addition, in combination with the operation of the optical unit drive mechanism 30, it is possible to carry out observation of the cells A over a the entire range of the glass slide 2.

Note that the actuation of the stepping motor 52 is controlled by a control unit (not illustrated). In addition, the stepping motor 52 and the ball screw 51 form the Y axis feeding mechanism 53.

The case in which the detection of the fluorescent light of the cells A is carried out by the cell cultivating and detecting device 1 having this type of structure will be explained below.

First, the Y axis feeding mechanism 53 of the optical unit drive mechanism 30 and the carrier conveying unit 50 is actuated, and position alignment is carried out such that the objective lens 22 is positioned directly under the cells A whose fluorescent light is to be investigated.

After position alignment, the collimated light L1, which is the excitation light from the light source 10, is emitted. The emitted collimated light L1 is incident on the inside of the base 21 through the entrance opening 21a of the moving optical unit 20, and passes through the excitation pinhole 23. Here, the light emitted from the light source 10 is the collimated light L1, and thus irrespective of the distance between the light source 10 and the moving optical unit 20, a light beam identical to the one emitted from the light source 10 is incident on the excitation pinhole 23.

When the collimated light L incident on the excitation pinhole 23 passes through the excitation pinhole 23, the diameter of the light beam is stopped and shaped. The collimated light L1 having the stopped diameter is deflected (reflected) 90° by the first wavelength selection element 25 after being focused by the projective lens 24. The deflected light is focused as a primary pinhole image at a position connected to the focal point in proximity to the downstream focal point position 25a, that is, the pupil position of the objective lens 22. In addition, the focused light is converted to a spot of light consisting of a collimated light beam having a small diameter by the objective lens 22, that is, collimated light having a constant cross-sectional area, and irradiates the cells A as excitation light via the stage 3 and the glass slide 2.

Note that the diameter of the spot of light 3 can be set to an arbitrary diameter that is a multiple of the objective lens 22. For example, in the case that the diameter of a cell A is 10 to 20 μm, preferably the diameter of the spot of light L3 is set to a light beam diameter that is equal to or less than this value, and furthermore, more preferably set to about 1/10 of the diameter of a cell A. By carrying out such a setting, it is possible to specify the position inside the cell A where the GFP or the like is expressed.

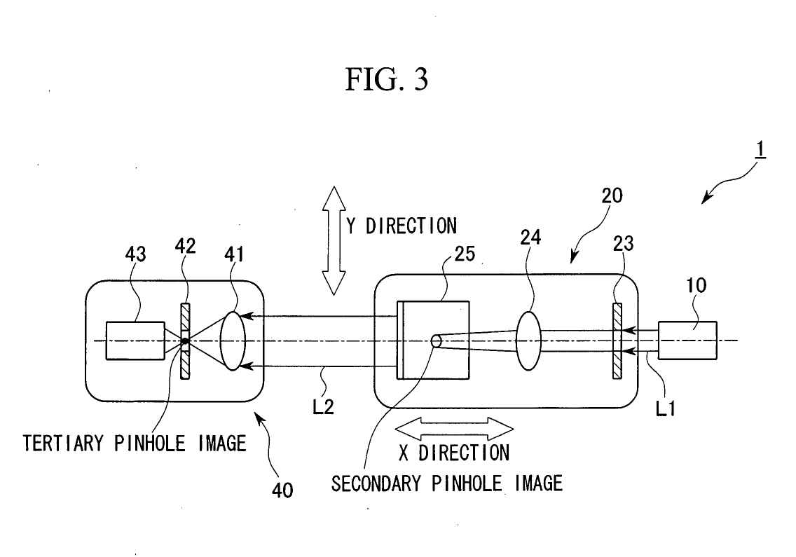

The spot of light L3 telecentrically irradiates the cells A on the glass slide 2 and produces a secondary pinhole image. Specifically, as shown in FIG. 3, the diffracted light produced by the excitation pinhole 23 produces the secondary pinhole image on the upper surface of the glass slide 2. Note that the point position of a cell A on the glass slide 2 is easily recognized by this secondary pinhole image.

In addition, the fluorescent light L2, which is the diffuse light emitted by the cells A due to the irradiation of the spot of light L3, serves as a second surface light beam or a substantially point light source, and is converted into collimated light again by the objective lens 22. The fluorescent light 2, which is this collimated light, passes through the first wavelength selection element 25 and is deflected (reflected) 90° by the second wavelength selection element 26 to be emitted by the exit opening 21b. At this time, in addition to the fluorescent light component that must be detected, unnecessary light is included in the fluorescent light L2 that has been transformed into collimated light by the objective lens 22. Examples of this additional unnecessary light include background fluorescence produced by the substrate, fluorescent light produced by the cells, and fluorescent light produced by the culture solution. However, this unnecessary light is cut by the second wavelength selection element, and only the component of the fluorescent light that must be detected is emitted towards the detecting unit 40. Furthermore, the fluorescent light L2 is emitted towards the detecting unit 40 as collimated light that has the same diameter that it had when emitted from the objective lens 22, and thus the fluorescent light L2 is emitted to the detecting unit 40 in a low loss state.

The fluorescent light emitted from the exit opening 21b is formed into an image by the image forming lens 41 of the detecting unit 40, and a tertiary pinhole image is produced at the focal point position downstream of the image forming lens 41. In addition, after passing through the light receiving pinhole 42 provided at the image forming position, the fluorescent light L2 is detected by the light detector 43. Thereby, the detecting unit 40 can detect the fluorescent light L2 emitted by the cells A.

At this time, by using a light receiving pinhole 42 that has a diameter substantially identical to that of the third pinhole image, it is possible to prevent the fluorescent light and the stray light generated outside the glass slide 2 surface from reaching the light detector 43. In addition, when the detecting unit 40 carries out the alignment of the focal point, the diffracted light produced by the excitation pinhole 23 described above produces a second pinhole image on the glass slide 2, and thus it is possible to carry out focal point alignment easily by using the second pinhole image as the reference.

As described above, after the detection of the fluorescent light of one cell A has been completed, the optical unit drive mechanism 30 and the carrier conveying unit 50 are moved, and the detection of the fluorescent light of all the cells A on the glass slide 2 is carried out.

For example, the detection of the fluorescent light of the cells A present in the X direction is carried out by moving the moving optical unit 20 in the X direction by using the optical unit drive mechanism 30. After the detection in the X direction has been completed, the stage 3 is feed in the Y direction only 1 pitch, where the diameter of the spot of light L3 is defined has having a pitch of 1. In addition, the detection of the fluorescent light is carried out by again moving the moving optical unit 20 in the X direction by the optical unit drive mechanism 30. In this manner, by repeating the scanning of the moving optical unit 20 in the X direction and then moving the stage 3 by 1 pitch, the detection of the fluorescent light of the cells is carried out by two-dimensional scanning over the entire detection region of the cells A on the glass slide 2.

As described above, because movement of the stage 3 in the Y direction is a small distance equivalent to 1 pitch of the diameter of the spot of light L3, it is possible to prevent the detachment of the cells A and the shaking of the culture solution. In addition, the moving optical unit 20 can move at a high speed in the X direction, and thus it is possible to reduce the time required for observation and thereby it is possible to increase the observation efficiency.

Note that to increase the resolution further, the carrier conveying unit 50 can be moved so as to feed the stage 3 by defining one-half the distance of the diameter of the spot of light as being a pitch of 1. That is, it is possible to set a feeding amount of 1 pitch unit depending on the desired resolution.

As described above, according to this cell cultivating and detecting device 1, the incident direction of the collimated light L2 incident on the moving optical unit 20 and the emitting direction of the fluorescent light L2 emitted from the moving optical unit 20 are parallel and the moving optical unit 20 moves in a parallel X direction. Thus, the detection of the fluorescent light of each of the cells A on the glass slide 2 can be carried out while scanning in one direction with respect to the glass slide 2. In this manner, detection of the fluorescent light of the cells A while scanning the moving optical unit 20 becomes possible, and thus it is possible to carry out fluorescent light detection without having to take into consideration the shaking of the culture solution and the detachment of cells or the like. Therefore, it is possible to move the moving optical unit 20 at a high speed, and thus it is possible to improve the observation efficiency of the cells A. In addition, the moving optical unit 20 is arranged using the minimum necessary structure separately from the light source 10 and the detecting unit 40, and thus it is possible make a scanning optical system that is small and simple in structure. Thereby, high speed scanning is possible, and it is possible to improve the observation efficiency. Furthermore, the light generated by the light source 10 is the collimated light L1, and thus it is possible to irradiate the cells with an even light spot L3, irrespective of the distance of the movement of the light source 10 and the moving optical unit 20.

In addition, two-dimensional scanning in the XY direction (planar direction) with respect to the glass slide 2 can be carried out using the movement of the moving optical unit 20 in the X direction by the optical unit drive mechanism 30 and the movement of the stage 3 in the Y direction by the carrier conveying unit 50. Therefore, it is possible to scan the entire range of the glass slide 2 and carry out the detection of fluorescent light of the cells A over a wider range. Furthermore, it is possible to increase the observation efficiency.

In addition, the moving optical unit 20 changes the fluorescent light L2 into collimated light by the objective lens 22, and thus the fluorescent light L2 can be emitted to the detecting unit 40 with the same diameter it has when emitted from the objective lens 22. Therefore, it is possible to emit the fluorescent light L3 emitted by the cells A to the detecting unit 40 with low loss, and it is possible carry out high precision analysis and the like. In addition, because it is possible to detect the fluorescent light L2 at the same intensity irrespective of the distance of the movement of the moving optical unit 20 and the detecting unit 40, it is possible to improve the precision of the detection.

Furthermore, the objective lens irradiates the cells A with a spot of light L3 consisting of collimated light having a comparatively small diameter, and thus even if the measured surface of the glass slide 2 is distorted or warped due to disturbances such as temperature, it is possible to irradiate cells while fluctuation of the diameter of the spot of light L3 is decreased. Therefore, the detection of the fluorescent light can be carried out more accurately. In addition, because a spot of light L3 is irradiated, the fluorescent light L2 generated by cells becomes substantially a point light source. Thus, even when the depth of focus is deep, the detecting unit 40 can accurately detect a sufficient amount of fluorescent light while the focal point is aligned on the cells.

In addition, using the first wavelength selection element 25 and the second wavelength selection element 26, it is possible to cut unnecessary light such as fluorescent light produced by the cells from the fluorescent light L2, which has been converted to collimated light by the objective lens 22. Therefore, the detecting unit 40 can accurately detect even fluorescent light having an extremely weak intensity, and thereby it is possible to increase the reliability.

In addition, the detecting unit 40 can cut stray light such as unnecessary diffuse light from the fluorescent light L2 due to the image forming lens 41 and the light receiving pinhole 24, and thus it is possible to accurately detect the amount of fluorescent light in the cells.

Furthermore, the light source 10 and the detecting unit 40 are disposed opposite to each other with the moving optical unit 20 interposed therebetween, and thus when the moving optical unit 20 is moved in the X direction, it approaches either one of the light source 10 or the detecting unit 40. That is, the distance between the light source 10 and the moving optical unit 20 and the distance between the moving optical unit 20 and the detecting unit 40 never becomes large at the same time. As the distance between each of the structural components becomes large, more installation precision and the like become required, but as described above, the distance between the light source 10 or the detecting unit 40 and the moving optical unit 20 do not become large at the same time, and thus it is possible to make the configuration simple.

Note that in the present embodiment, a light receiving pinhole 42 having a diameter that is substantially identical to that of the tertiary pinhole image is used. However, this is not limiting, and it is also possible to use a light receiving pinhole 42 having a diameter that is larger than that of the tertiary pinhole image. In this case, it is possible to detect the total amount of fluorescent light from the cells A on the glass slide 2 by the light detector 43, it is possible to decrease further the measurement time taken by the scanning, and thus it is possible to improve the observation efficiency. In addition, it is possible to use a light receiving pinhole 42 having a diameter that is smaller than that of the tertiary pinhole image. In this case, it is possible to observe the fluorescent light from a part of the inside of a cell A, and thus by measuring light while scanning in sequence, it is possible to image and analyze the fluorescent light distribution of the cells A.

In addition, an optical or magnetic position sensor can be provided on the optical unit drive mechanism 30 and the Y axis feeding mechanism 50 of the carrier conveying unit 50, and the position coordinates accompanying the scanning in each direction can be detected. In this case, it is possible to detect accurately the position where the fluorescent light is generated, the values of the fluorescent light generation position and the fluorescent light intensity can be read into a computer and processed, and thereby it is possible to express the fluorescent light from the cells A on the glass slide 2 as a two-dimensional image. Furthermore, it is possible graph the fluctuation in the intensity of the fluorescent light focusing on one cell A as a function of time. In addition, the morphology and amount of fluorescent light of the cultured cells A changes depending on the activity cycle, but because it is possible to recognize the position coordinates of the fluorescent light that has been detected by a position sensor or the like, it is possible to carry out a cellular analysis of the function of proteins or the like by the correlations between the amount of fluorescent light emitted by the cells A, the position data for the generated fluorescent light, and the time during which the cells A are cultivated. Furthermore, because the detecting unit 40 is stationary, the influence of vibrations or the like due to scanning is negligible, and thus it is possible to carry out accurate detecting.

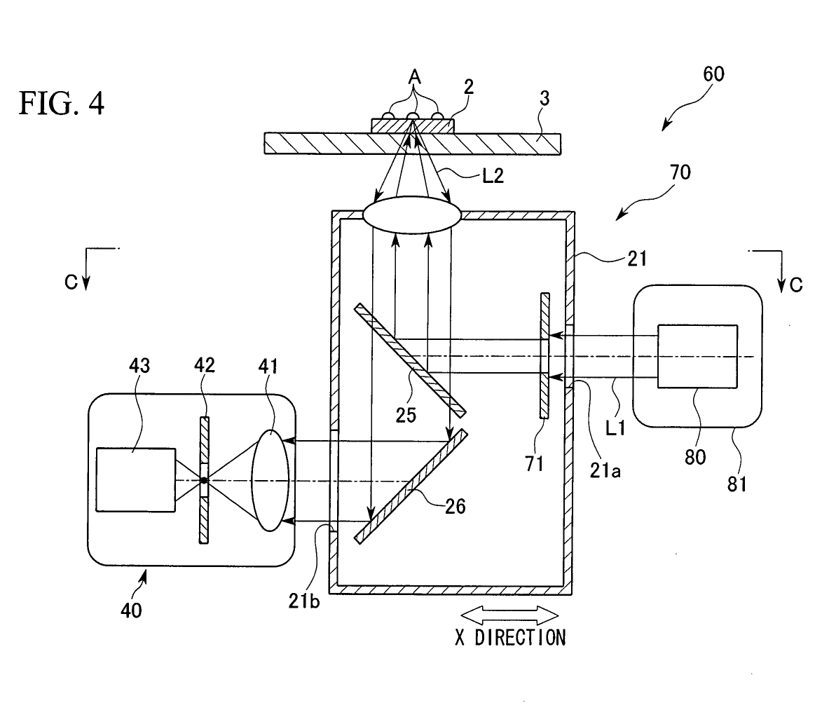

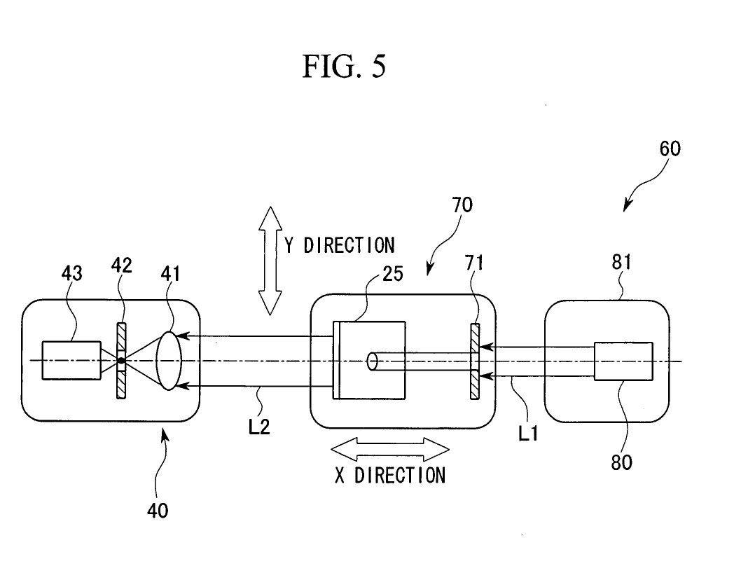

Next, a second embodiment of the cell cultivating and detecting device according to the present invention will be explained with reference to FIG. 4 and FIG. 5. In the second embodiment, essential components identical to those of the first embodiment are denoted by identical reference numerals, and their explanation has been omitted.

The point of difference between the second embodiment and the first embodiment is that in the first embodiment, after the collimated light L1 incident from the light source 10 is deflected by the first wavelength selection element 25 after having passed through the excitation pinhole 23 and focused by the projective lens 24, whereas, in the cell cultivating and detecting device 60 in the second embodiment, the collimated light L1 incident from the light source 80 is deflected by the first wavelength selection element 25 after passing through the excitation pinhole 71.

That is, as shown in FIG. 4, in the case 21, the moving optical unit (irradiation unit) 70 of the cell cultivating and detecting device 60 of the present embodiment provides an objective lens 22, an excitation pinhole (projective pinhole) 71 disposed on the optical path of the collimated light L1 incident from the light source 80, a first wavelength selection element 25 that deflects the light that has passed through the excitation pinhole 71 towards the cells A, and a second wavelength selection element 26 that modifies the fluorescent light L2, which is the collimated light that has been converted by the objective lens 22, and emits the same towards the detecting unit 40.

The excitation pinhole 71 is disposed inside the entrance opening 21a of the case 21 and is a plate-shaped member providing a small pinhole. It functions to shape (stop) the diameter of the collimated light L1. Note that the excitation pinhole 71 can be structured so as to be variable, such that the pinhole diameter can be arbitrarily altered. In addition, the light source 80 is accommodated inside the light source unit 81.

Below, the case of carrying out the detection of the fluorescent light of the cells A by the cell cultivating and detecting device 60 configured in this manner will be explained.

After positioning and aligning of the objective lens 22 by the optical unit drive mechanism 30 and the carrier conveying unit 50, the collimated light L1 is emitted from the light source 80. The emitted collimated light L1 is emitted into the case 21 by the entrance opening 21a and the diameter is stopped and shaped by the excitation pinhole 71. Note that if the objective lens 22 is a NA 0.1 lens and the diameter of the excitation pinhole 71 is 1 mm, then d=1.2λ/0.1=5.8 μm. As described above, it is possible to handle various objects of analysis because variable control of the diameter of the excitation pinhole 71 can be carried out.

In addition, the collimated light L1 that has passed through the excitation pinhole 71 is deflected 90° by the first wavelength selection element 25, then focused by the objective lens 22, and focused and irradiated on the cells A on the glass slide 2. At this time, the diameter of the light beam is set to an arbitrary diameter depending on the magnification of the objective lens 22. For example, in the case of an objective lens 22 having a low magnification, it is possible to have a light beam with a diameter that is several times to several tens of times the diameter of a cell A, and thereby it is possible to rapidly and comprehensively scan the entire surface of the glass slide 2.

In contrast, the fluorescent light L2 emitted by the cells is converted to a collimated light by the objective lens 22, and thus passes through the first wavelength selection element 25, unnecessary light is cut by the second wavelength selection element 26, the light is deflected 90°, and then emitted towards the detecting unit 40 by the exit opening 21b. Then after the emitted fluorescent light L2 has been formed into an image by the image forming lens 41 of the detecting unit 40, it passes through the light receiving pinhole 42 to be detected by the light detector 43. In this manner, the detecting unit 40 can detect the fluorescent light L2 emitted by the cells A.

Note that in the present embodiment, the diameter of the light receiving pinhole 42 is set slightly larger than the diameter calculated from the NA of the emitting side of the image forming lens 41.

According to this cell cultivating and detecting device 60, because a structure is possible wherein the parts of the moving optical unit 60 are further reduced, it is possible to release a decrease in size and weight. Therefore, it is possible to scan at an even higher speed, and thus it is possible to improve the observation efficiency. In addition, because the depth of the focal point is shallow, the influence of fluorescent light produced by the cells or in the culture solution during focusing becomes small, and it is possible to carry out the measurement with little noise. Furthermore, the resolution is high, and thus it is possible to carry out precise measurement of a small portion, for example, one cell A.

Note that the technical scope of the present invention is not limited by the above embodiments, and various modifications can be made within a scope that does not depart from the gist of the present invention.

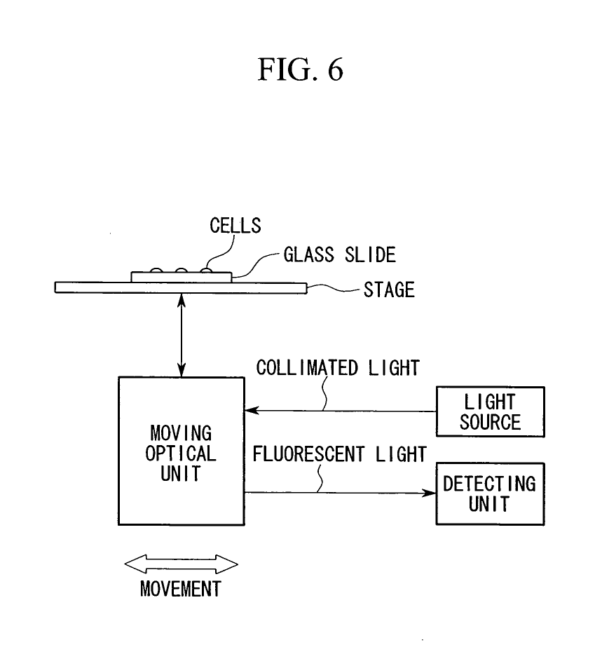

For example, in each of the embodiments described above, the light source and the detecting unit were disposed so as to be opposite each other and having the moving optical unit interposed therebetween. However, this is not limiting, and as shown in FIG. 6, the light source and the detecting unit can be disposed on the same side with respect to the moving optical unit. In this case, ample disposition space is not necessary, and the apparatus can be made compact.

In addition, a glass slide was used as a carrier, but a 96-hole microplate or a 384-hole microplate can be used. Here, the cells are cultivated in each of the holes, and at the bottom (bottom surface side) of the microplate, it is possible to measure the intensity of the fluorescent light from the cell cultivation.

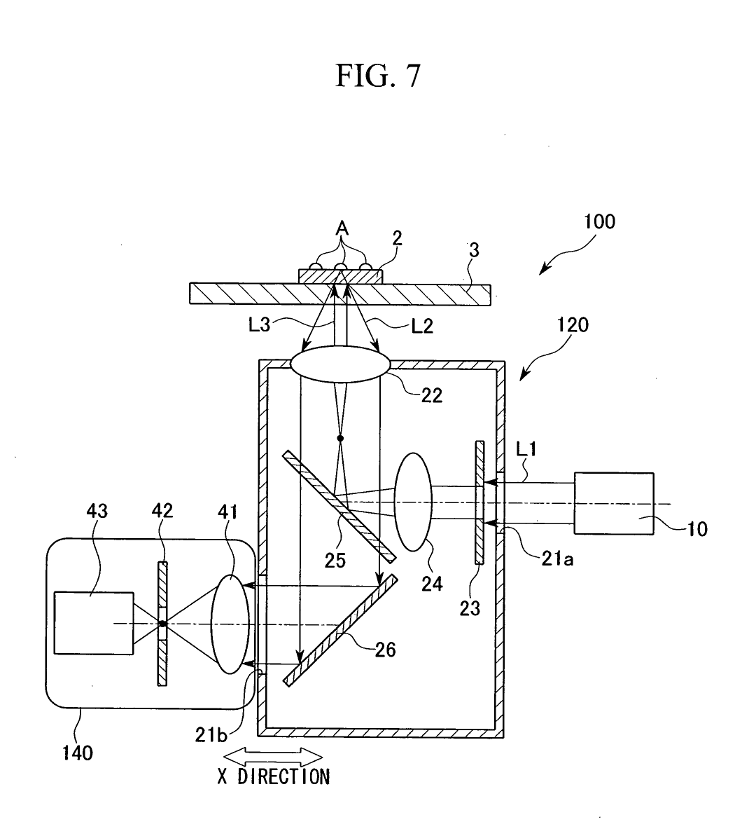

Next, a third embodiment of the cell cultivating and detecting device according to the present invention will be explained with reference to FIG. 7. In the third embodiment, essential components identical to those of the first embodiment are denoted by identical reference numerals, and their explanation has been omitted.

The point of difference between the third embodiment and the first embodiment is that in the first embodiment, the moving optical unit 20 and the detecting unit 40 are separated, whereas, in the cell cultivating and detecting device 100 in the third embodiment, a detecting unit 140 is fixed to a moving optical unit 120.

In the cell cultivating and detecting device 100, because the moving optical unit 120 and the detecting unit 140 are combined, even when the moving optical unit 120 and the detecting unit 140 are moved at a high speed, deviations of the focal points of the collimated light from the light source 10 and of the emitted fluorescent light can be prevented.

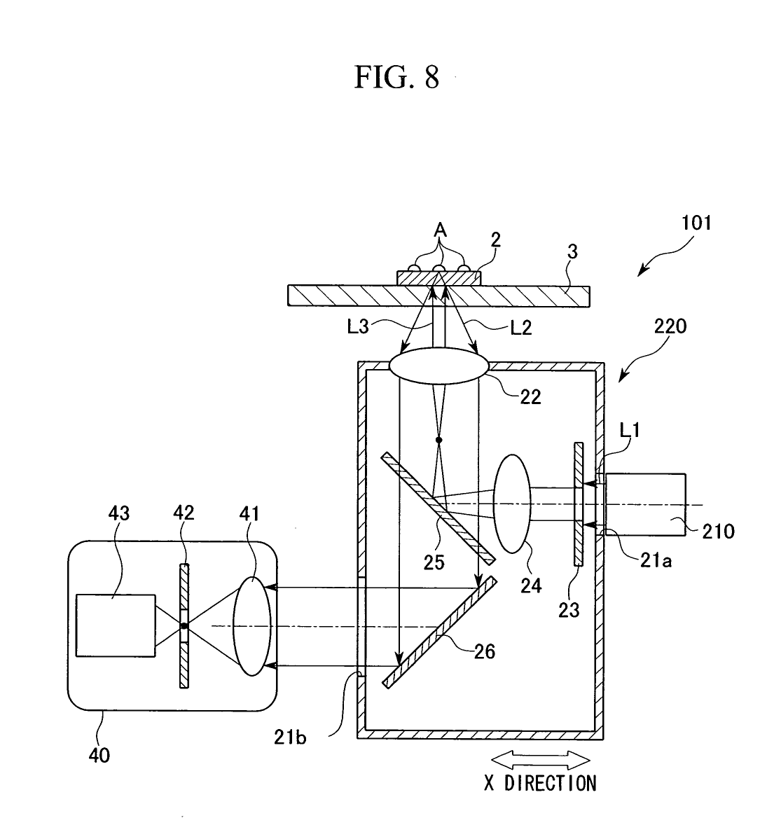

Next, a fourth embodiment of the cell cultivating and detecting device according to the present invention will be explained with reference to FIG. 8. In the fourth embodiment, essential components identical to those of the first embodiment are denoted by identical reference numerals, and their explanation has been omitted.

The point of difference between the fourth embodiment and the first embodiment is that in the first embodiment, the light source 10 and the moving optical unit 20 are separated, whereas, in the cell cultivating and detecting device 101 in the fourth embodiment, a light source 210 is fixed to a moving optical unit 220.

In the cell cultivating and detecting device 101, because the light source 210 and the moving optical unit 220 are combined, even when the light source 210 and the moving optical unit 220 are moved at a high speed, deviations of the focal points of the collimated light from the light source 210 and of the emitted fluorescent light can be prevented.

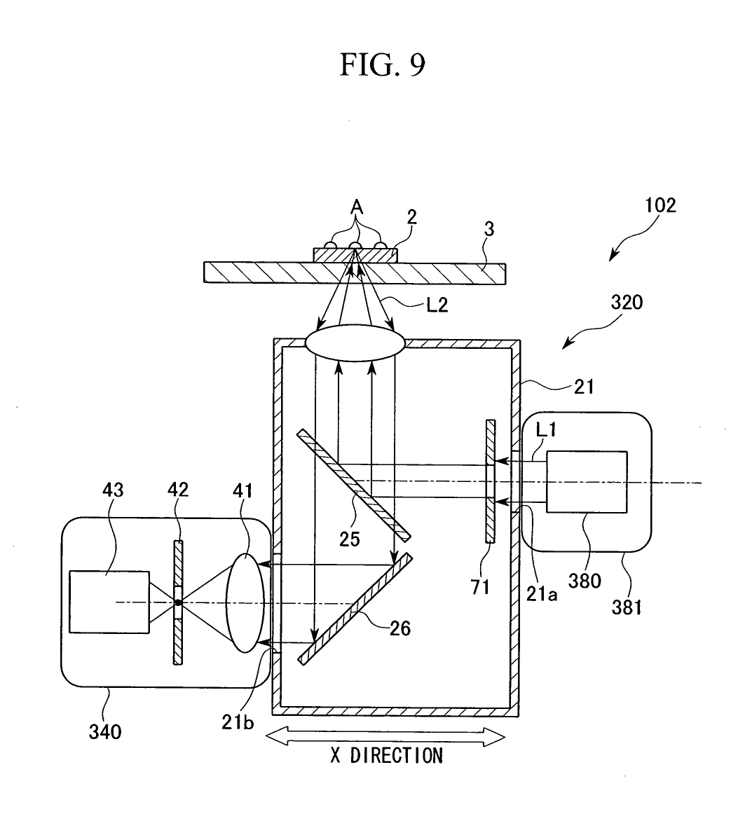

Next, a fifth embodiment of the cell cultivating and detecting device according to the present invention will be explained with reference to FIG. 9. In the fifth embodiment, essential components identical to those of the second embodiment are denoted by identical reference numerals, and their explanation has been omitted.

The point of difference between the fifth embodiment and the second embodiment is that in the first embodiment, the light source 80, the moving optical unit 20 and the detecting unit 40 are separated, whereas, in the cell cultivating and detecting device 102 in the fifth embodiment, a light source 380 and a detecting unit 340 is fixed to a moving optical unit 320.

In the cell cultivating and detecting device 101, because the light source 380, the detecting unit 340, and the moving optical unit 320 are combined, even when they are moved at a high speed, deviations of the focal points of the collimated light from the light source 380 and of the emitted fluorescent light can be prevented.

As explained above, according to the cell cultivating and detecting device of the present invention, it is possible to carry out detection of the fluorescent light of the cells while scanning on the irradiation unit side, not the carrier side where cells are present, and thus is it possible to carry out detection of the fluorescent light without having to take into consideration shaking of the culture solution or detachment of the cells and the like. Therefore, it is possible to move the irradiation unit at a high speed, and it is possible to improve the efficiency of the observation of the cells. In addition, the irradiation unit is disposed separately from the light source and the detecting unit, and thus the minimum necessary configuration becomes possible. Thereby, it is possible to make a scanning optical system that is small and has a simple structure, high speed scanning becomes possible, and it is possible to improve the observation efficiency.

In the cell cultivating and detecting device according to the present invention, the irradiation unit irradiates the cells with the collimated light generated by the light source irradiates cells, and the fluorescent light emitted from the cells due to the emitting of this light is emitted towards the detecting unit by the irradiation unit. Thereby, it is possible for the detection unit to carry out detection and analysis of the fluorescent light emitted by the cells. Here, the incident direction and the emitting direction are arranged in parallel and the irradiation unit can be moved in a direction parallel thereto, and thus the detection of the fluorescent light of each cell on the carrier is possible while scanning in one direction with respect to the carrier.

In this manner, it is possible to carry out detection of the fluorescent light of the cells while scanning not only on the carrier side where cells are present, but also on the irradiation unit side. Thus, it is possible to carry out the fluorescent light detection without having to take into consideration shaking of the culture solution or detachment of the cells. Therefore, it is possible to rapidly move the irradiation unit, and thereby it is possible to improve the observation efficiency of the cells. In addition, the irradiation unit is disposed separately from the light source and detecting unit, and thus it is possible to provide a minimal necessary configuration, and it is possible to make a scanning optical system that is small and simple. Thus, rapid scanning is possible, and thereby it is possible to increase the observation efficiency. Furthermore, the light generated by the light source is collimated, and thus it is possible to irradiate the cells with a spot of light that is uniform irrespective of the distance of the movement of the light source and the irradiation unit.

In the cell cultivating and detecting device according to the present invention, scanning in the XY direction (the planar direction) with respect to the carrier is possible by the movement of the carrier conveying unit and the movement of the irradiation unit. Therefore, the observation efficiency can be further improved because it is possible to scan over the entire range of the carrier and thereby carry out detection of the fluorescent light of the cells over a wider range. Here, the irradiation unit can be rapidly moved as described above, and thus only fine movement of the carrier conveying unit is necessary. Therefore, shaking of the cultivating solution does not occur and no load is applied to the cells.

In the cell cultivating and detecting device according to the present invention, the irradiation unit changes the fluorescent light into collimated light by the objective lens, and thus it is possible to emit the fluorescent light to the detecting unit having the same diameter it has when emitted from the objective lens. Therefore, it is possible to emit the fluorescent light emitted by the cells to the detecting unit at low loss. In addition, the light that the irradiation unit emits is collimated light, and thus it is possible to detect the fluorescent light that has identical intensity irrespective of the distance of the movement of the irradiation unit and the detecting unit. Thereby, the precision of the detecting can be improved.

In the cell cultivating and detecting device according to the present invention, the collimated light is focused by the projective lens and the light that has passed through the projective lens is deflected towards the cells by the deflecting element. In addition, the focused light is again changed into collimated light after deflection by the deflecting element. Thereby, it is possible to irradiate the cells with a spot of light consisting of collimated light having a comparatively small light beam diameter. Therefore, even if the surface of the carrier to be measured is distorted or warped due to disturbances such as temperature, it is possible to irradiate cells while fluctuation of the diameter of the spot of light is decreased, and thus fluorescent light detection can be carried out more accurately. In addition, because a spot of light is irradiated, the fluorescent light generated by cells becomes substantially a point light source. Thus, even when the depth of focus is deep, the detecting unit can accurately detect a sufficient amount of fluorescent light while the focal point is aligned on the cells.

In the cell cultivating and detecting device according to the present invention, the projective pinhole shapes (stops) the collimated light and the projective lens focuses the light that has been shaped by passing through the projective pinhole. In addition, the light that has passed through the projective lens is deflected towards the cells by the first wavelength selection element. Here, the projective lens is disposed such that the upstream focal position aligns with the projective lens, and thus the shaped light can be reliably focused at the downstream focal position. In addition, because the light that has been focused after deflection is changed again into collimated light by the objective lens, it is possible to irradiate the cells with a spot of light consisting of collimated light having a comparatively small light beam diameter, and thus more accurate light detection can be carried out. In addition, because only, for example, a light of a predetermined wavelength necessary for fluorescent light detection is selected and deflected by the first wavelength selection element, it is possible to carry out more accurate fluorescent light detection.

In addition, because a spot of light is irradiated, the fluorescent light emitted by the cells provides a substantially point light source. Thereby, even when the focal point depth is deep, the detecting unit can accurately detect a sufficient amount of fluorescent light while the focal point is aligned on the cells.

Furthermore, the fluorescent light that has been converted to collimated light by the objective lens is deflected by the second wavelength selection element, and then is emitted towards the detecting unit. At this time, like the first wavelength selection element, it is possible to select only light having the wavelength that must be detected and emit the same to the detecting unit. Specifically, it is possible to cut excess light such as the fluorescent light produced by the cells and included in the fluorescent light. Therefore, it is possible to accurately detect even an extremely weak fluorescent light intensity, and thereby it is possible to increase the reliability.

In the cell cultivating and detecting device according to this invention, the collimated light incident from the light source is deflected towards the cells by the deflecting element. In addition, the collimated light deflected by the objective lens is focused to irradiate the cells. Therefore, because the structure can be simplified by reducing the number of parts, it is possible to realize a small size and a light weight, and thereby, a higher speed scanning becomes possible.

In the cell cultivating and detecting device according to this invention, the projective pinhole shapes (stops) the collimated and the first wavelength selection element deflects this shaped light that has passed through the projective pinhole towards the cells. In addition, because the light that has been focused after being deflected by the objective lens is converted again to collimated light, it is possible to irradiate the cells with a spot of light consisting of collimated light having a comparatively small light beam diameter, and thus it is possible to carry out more accurate fluorescent light detection. In addition, because, for example, only light having a predetermined wavelength that is necessary for the fluorescent light detection is selected and deflected by the first wavelength selection element, it is possible to carry out more accurate fluorescent light detection.

In addition, because a spot of light is irradiated, the fluorescent light emitted by the cells provides a substantially point light source. Thereby, even when the depth of focus is deep, the detecting unit can accurately detect a sufficient amount of fluorescent light while the focal point is aligned on the cells.

Furthermore, the fluorescent light that has been converted to collimated light by the objective lens is deflected by the second wavelength selection element and then is emitted towards the detecting unit. At this time, like the first wavelength selection element, it is possible to select only light having the wavelength that must be detected and emit the same to the detecting unit. Specifically, it is possible to cut excess light such as the fluorescent light produced by the cells and included in the fluorescent light. Therefore, it is possible to accurately detect even an extremely weak fluorescent light intensity, and thereby it is possible to increase the reliability.

In the cell cultivating and detecting device according to this invention, the fluorescent light emitted from the irradiation unit by the image forming lens is formed into an image, and the fluorescent light that has passed through the light receiving pinhole is detected by the light detector. Here, the light receiving pinhole is provided at the image formation position of the image forming lens, and thus, for example, it is possible to cut stray light such as unnecessary diffuse light from the fluorescent light incident from the irradiation unit, and thus the amount of the fluorescent light of the cells can be accurately detected.

In the cell cultivating and detecting device according to this invention, when the irradiation unit is moved in a direction parallel to the incident direction and the emitting direction, the irradiation unit approaches one of either the light source or the detecting unit. This means that the distance between the light source and the irradiation unit and the distance between the irradiation unit and the detecting unit do not become long distances at the same time. For example, when the distance between the light source and the irradiation unit is large, precision is required in the installation of both in order to make the collimated light reliably incident. In this manner, the longer the distance between each of the parts, the more installation precision is required, but as described above, easy configuration is possible because the distance between the light source and the detecting unit and the irradiation unit does not become large.

In the cell cultivating and detecting device according to this invention, because the light source and the detecting unit are arranged on the same side, it is possible to form the device compactly as whole.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A cell cultivating and detecting device that irradiates cells in a culture with light and detects light emitted from the cells, and comprises:
a light source that generates collimated light;
an irradiation unit that irradiates cells with the collimated light incident from the light source and emits the light that is emitted from the cells;
a detecting unit that detects the light emitted from the irradiation unit, and wherein the irradiation unit can move in a direction parallel to the collimated light.

2. A cell cultivating and detecting device according to the claim 1, comprising:
a carrier on which the cells are cultivated; and
a carrier conveying unit that supports the carrier so as to be able to move in a direction perpendicular to this parallel direction.

3. A cell cultivating and detecting device according to claim 1, wherein the incident direction of the light into the irradiation unit and the emitting direction of the light from the irradiation unit are arranged so as to be substantially parallel.

4. A cell cultivating and detecting device according to claim 1, wherein
the irradiation unit focuses the collimated light incident from the light source and irradiates cells with the collimated light.

5. A cell cultivating and detecting device according to claim 4 comprises:
a projective lens that focuses the collimated light incident from the light source.

6. A cell cultivating and detecting device according to claim 5 comprises:
a deflecting element that deflects the light that has passed through the projective lens towards the cells; and
an objective lens that changes light focused onto a focal position downstream of the deflecting element into collimated light to irradiate the cells.

7. A cell cultivating and detecting device according to claim 1 wherein
the irradiation unit changes the light emitted by the cells into a collimated light, and emit the collimated light.

8. A cell cultivating and detecting device according to claim 7, wherein the irradiation unit provides an objective lens that changes the light emitted by the cells into a collimated light.

9. A cell cultivating and detecting device according to claim 8, wherein the irradiation unit provides a deflecting element that deflects the collimated light incident from the light source towards the cells; and further wherein:
the objective lens irradiates the cells with the light deflected by the deflecting element.

10. A cell cultivating and detecting device according to claim 8, comprising:
a projecting pinhole disposed on the optical path of the collimated light incident from the light source;
a first wavelength selecting element that deflects light that has passed through the projecting pinhole towards the cells; and
a second wavelength selecting element that deflects collimated light converted by the objective lens and emits the same towards the detecting unit; and wherein:
the objective lens irradiates the cell with deflected by the first wavelength selective element.

11. A cell cultivating and detecting device according to claim 7, wherein
the irradiation unit comprises a projective pinhole that is disposed on the optical path of the collimated light incident from the light source.

12. A cell cultivating and detecting device according to claim 11, wherein
the pinhole diameter of the projective pinhole can be set to an arbitrary diameter.

13. A cell cultivating and detecting device according to claim 11, wherein
the irradiation unit is disposed so as to align the upstream focal point with the projective pinhole, and provides a projective lens which focuses the light that has passed through the projective pinhole.

14. A cell cultivating and detecting device according to claim 13, comprising:
a first wavelength selecting element that deflects the light that has passed through the projective lens towards the cells; and
an objective lens that changes the light focused on the focal position downstream of the first wavelength selecting element into collimated light to irradiate the cells; and
a second wavelength selecting element that deflects emitted from the cell and emits the light towards the detecting unit.

15. A cell cultivating and detecting device according to claim 1, wherein
the detecting unit comprises a light detector that detects the fluorescent light that has passed through a fluorescent light irradiation unit.

16. A cell cultivating and detecting device according to claim 15, wherein
the detecting unit comprises an image forming lens that forms the fluorescent light emitted from the irradiation unit into an image.

17. A cell cultivating and detecting device according to claim 16, wherein
the detecting unit comprises a light receiving pinhole provided at the image formation position of the image forming lens; and
a light detector that detects the fluorescent light that has passed through the light receiving pinhole.

18. A cell cultivating and detecting device according to claim 17, wherein
a pinhole diameter of the light receiving pinhole has substantially the same diameter as a pinhole image formed at the focal point of the fluorescent light by the image forming lens.

19. A cell cultivating and detecting device according to claim 17, wherein
a pinhole diameter of the light receiving pinhole is larger than a pinhole image formed at the focal point of the fluorescent light by the image forming lens.

20. A cell cultivating and detecting device according to claim 17, wherein
a pinhole diameter of the light receiving pinhole is smaller than a pinhole image formed at the focal point of the fluorescent light by the image forming lens.

21. A cell cultivating and detecting device according to claim 17, wherein
a pinhole diameter of the light receiving pinhole is larger than the diameter calculated from an NA of an emitting side of the image forming lens.

22. A cell cultivating and detecting device according to claim 1, wherein the detecting unit is arranged opposite to the light source with the irradiation unit interposed therebetween.

23. A cell cultivating and detecting device according to claim 1, wherein the detecting unit is arranged on the same side as the light source with respect to the irradiation unit.

24. A cell cultivating and detecting device according to claim 1, wherein the light source is fixed to a frame of the cell cultivating and detecting device.

25. A cell cultivating and detecting device according to claim 1, wherein the detecting unit is fixed to a frame of the cell cultivating and detecting device.

26. A cell cultivating and detecting device according to claim 1, wherein at least one of the light source and the detecting unit is fixed to the irradiation unit.
